(19) United States
(12) Patent Application Publication
(10) Pub. No.: US 2024/0364528 A1
(43) Pub. Date: Oct. 31, 2024

(54) CRYPTOGRAPHIC KEY PAIR GENERATION FROM ECG SIGNALS

(71) Applicant: Tenbeo bv, Ukkel (BE)

(72) Inventors: Bjorn-Jostein SINGSTAD, Ukkel (BE); Theodosis MOUROUZIS, Ukkel (BE); Georgios DELKOS, Ukkel (BE); Athalis Dimitra KRATOUNI, Ukkel (BE)

(21) Appl. No.: 18/647,262

(22) Filed: Apr. 26, 2024

(30) Foreign Application Priority Data
Apr. 26, 2023 (BE) 2023/5329

(51) Int. Cl. H04L 9/32; H04L 9/08; H04L 9/30

(52) U.S. Cl. CPC H04L 9/3231; H04L 9/0861; H04L 9/3073

(57) ABSTRACT

The present invention concerns an electrocardiogram based two-factor authentication method and system. A wearable device provides the necessary ECG signals for both the creation of hash-based keys and a user authentication machine learning model for user authentication, as well as a storage place for a generated private key. The access to said private key requiring user authentication by means of real time ECG signals.

### CROSS REFERENCE TO RELATED APPLICATIONS

The present application claims priority to and benefit of Belgian Patent Application No. BE2023/5329, filed on Apr. 26, 2023, the entire disclosure of which is incorporated herein by reference.

### FIELD OF THE INVENTION

The present invention relates to a two-factor identification method and system. In particular, the present invention relates to a method and system for two-factor identification based on biological signal of a user.

### BACKGROUND

CA2835460 describes a system and method for enabling continuous or instantaneous identity recognition based on physiological biometric signals. CA '460 describes a biometric security system and method operable to authenticate one or more individuals using physiological signals. CA '460 discloses a distributed system for a small-scale recognition framework, wherein, every user has an electronic device that is enabled with biometric authentication method or system operable to use physiological signals. The electronic device may be personalized by securely storing on it the biometric template of the respective individual.

U.S. Pat. No. 8,489,181 describes a method and associated system for use of statistical parameters based on peak amplitudes and/or time interval lengths and/or depolarization-repolarization vector angles and/or depolarization-repolarization vector lengths for PQRST electrical signals associated with heart waves, to identify a person. The statistical parameters, estimated to be at least 192, serve as biometric indicia, to authenticate, or to decline to authenticate, an asserted identity of a candidate person. A full ECG analysis with a modified version in which, as one example, timed measurements of signals sensed at two or more fingers or thumbs, pressed against separate sensing pads, and time shifted correlations are analyzed to distinguish between certain persons. activities; access to weapons storage and weapons maintenance facilities; access to encryption codes and associated keys.

There remains a need in the art for a system and method which improves on the safety of known method and systems for user authentication. In particular, the present invention aims to remove the possibility of users creating weak passwords which can render them vulnerable to attacks e.g. dictionary attacks, brute force, etc.

### SUMMARY OF THE INVENTION

The present invention and embodiments thereof serve to provide a solution to one or more of above-mentioned disadvantages. To this end, the present invention relates to an electrocardiogram based two-factor authentication method.

According to an embodiment of the present disclosure, the method permits the creation of a private key, which private key is created based on the parameters of a machine learning model for recognizing the user to which said private key is assigned. In this way both the private key as well as the machine learning model required to authenticate the user and access said key are made safer than if the user were to choose a password. Given that the heartbeat of each user has unique features that set it apart from heartbeats of other users, safety of the private key as well as the performance of the machine learning model is advantageously and greatly improved.

In a second aspect, an embodiment of the present disclosure relates to a system for cryptographic key pair generation from ECG signals and user authentication based on said ECG signals. An embodiment of the present disclosure includes a weight file, wherein the weight file, the salt and info values to be compiled dynamically to re-create the private key can be stored in a wearable device or other device such as a mobile phone. In this way, recreation of both the private key and the public key is made impossible without access to the chosen device. In order to further ensure the safety of said information, weight file, the salt and info values to be compiled dynamically to re-create the private key are stored in a secured enclave within the selected device, which secured enclave requires user identification by means of ECG verification in order to be accessed. In this way, even if the device is stolen or lost, the private key cannot be recompiled as the weight file, the salt and info values cannot be accessed since they are stored encrypted in the secured enclave in the memory of the wearable device.

### DESCRIPTION OF FIGURES

The following description of the FIGURES of specific embodiments of the invention is merely exemplary in nature and is not intended to limit the present teachings, their application or uses. Throughout the drawings, corresponding reference numerals indicate like or corresponding parts and features.

FIG. 1 shows a schematic representation of the system for user registration and authentication

### DETAILED DESCRIPTION OF THE INVENTION

The present invention concerns an electrocardiogram based two-factor authentication method. The method permits the creation of a private key, which private key is created based on the parameters of a machine learning model for recognizing the user to which said private key is assigned. In this way both the private key as well as the machine learning model required to authenticate the user and access said key are made safer than if the user was to choose a password. Given that the heartbeat of each user has unique features that set it apart from heartbeats of other users, safety of the private key as well as the performance of the machine learning model is advantageously and greatly improved.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the following claims, any of the claimed embodiments can be used in any combination.

A first aspect of the invention relates to an electrocardiogram based two-factor authentication method comprising the steps of:
collecting electrocardiogram, ECG, data from a user;
training a machine learning model based on the collected data; and
generating a private user key and a public user key.

The step of generating a private user key and a public user key generates said keys by means of a hash-based function taking a vector containing weight parameters of the created machine learning model as input. The recompilation of the private key requiring electrocardiogram-based user identification by means of the machine learning model. Considering that the ECG signals are unique to each individual, the machine learning model created for said individual is also unique. The use of the parameters of the machine learning module of an individual advantageously permit the creation of unique keys which do not require the user to set up a password. In this way, the keys are not endangered by poor password choices on the part of the user, while at the same time reducing the effectiveness of security attacks such as dictionary attacks, collision attacks, etc. The method requires live ECG signal of the user in order to authenticate said user and unlock the recreation/recompilation of the keys. Where further security is necessary, it is possible to implement the same method such that a predetermined number of individuals, including the user, must first be authenticated before the keys of the user can be recreated/recompiled. This requires collecting an ECG and training a machine learning model for said additional individuals. Unlocking of the recreation/recompilation of the keys may be attained if the user and at least one of the predetermined individuals are successfully authenticated. This number of individuals which must be authenticated before recreation/recompilation of the keys is allowed can be raised, according to the desired level of security. By preference all of the predetermined individuals must be authenticated before recreation/recompilation of the keys is allowed.

In this context, a “wearable device” or simply a “wearable” is to be understood as any device which can be easily transported by a user, whether in constant contact with the skin of the user or capable of being put in contact with the skin of the user. Examples of such devices include, but are not limited to smart watches, or any ECG capturing device which may directly or via at least another device communicate with a server.

In an embodiment, training the machine learning model includes the steps of:
sampling a waveform of the ECG data; and
training the machine learning model on a mixture of heartbeat data collected from the user as well as data collected from other users.

The machine learning model is trained on a mixture of heartbeat data collected from the user as well as data collected from other users. By preference, the sampling frequency of the ECG data is between 40 Hz and 300 Hz, more preferably between 60 Hz and 250 Hz, 70 Hz and 200 Hz, 75 Hz and 180 Hz, 80 Hz and 150 Hz, 85 Hz and 130 Hz, 90 Hz and 120 Hz, most preferably the sampling frequency of the ECG is 100 Hz. In this way, sufficient datapoints are available to recognize a user with sufficient reliability while still being enough to avoid false positives. This advantageously permits a good balance between safety and user identification efficiency and reliability. By training the machine learning model using multiple example heartbeats collected from a user as well as from other users, it advantageously becomes possible to account not only for differences between the heartbeat of the user relative to the heartbeats of other users, but allows also to account for the variability between heartbeats of the user. In this way, the model can much more reliably can determine if a new sample is collected from the same user or from someone else. Another advantage is the ability of the machine learning model to distinguish between previously recorded heartbeats of the user and current user's heartbeats captured in real time. In this way, it becomes virtually impossible to achieve user recognition without capturing the heartbeat of the user at the time said recognition is attempted.

In an embodiment, the hash-based function is a key derivation function based on hash-based message authentication code, HKDF (Hashed Key Derivation Function). HKDF is a widely used in critical protocols such as transport layer security due to its high resistance to attacks such as, but not limited to, backdoor attacks. By preference, salt is used in HKDF, thereby greatly increasing the security of the produced key.

In this context, the term “Salt” or “Salting” is understood as random data that is used as an additional input to a one-way function that hashes data, a password or passphrase.

In an embodiment, the step of generating a private and a public key includes the steps of:
extracting the vector containing parameters of the created machine learning model;
passing said vector to the HKDF to create a pseudo-random private key;

The pseudo-random private key is passed onto an asymmetric key generation algorithm in order to generate a public key. This makes it impossible to regenerate the public key without access to the private key. By preference, the private key is created using entropy values collected from the machine learning model.

In this context, the term “entropy” is to be understood as the randomness or measuring the disorder of the information being processed in Machine Learning. In other words, entropy is the machine learning metric that measures the unpredictability or impurity in the system. The term impure here defines non-homogeneity.

By preference, the asymmetric key generation algorithm is an elliptic curve digital signature algorithm, ECDSA. In this way, faster computation is made advantageously possible, allowing for the use of resource constrained devices while keeping a high level of security. Other key generation algorithms can optionally be utilized to provide additional functionality such as quantum resistance. Examples of such other key generation algorithms are for instance MPPK/DS, Dilithium, SPHINCS+, or others.

In an embodiment, the extracted vector containing parameters of the created machine learning model is encoded in base 64 before being passed onto the HKDF. By preference, the method further contains a step of creating a reduced vector containing only the values corresponding to the positions of the output vector of the step of encoding the machine learning model in base 64 which positions have a prime index number, said reduced vector being passed onto the HKDF.

In an embodiment, an info vector and a salt vector are used as initialization vectors of the HKDF. Salt and info are used as extra parameters for selecting random permutation through set of possible information. This permits mitigating any hash table attacks by imposing higher computational demands on the attackers, while keeping the computational requirements on authorized operations to remain virtually unchanged.

In this context, the “info” used as one of the extra parameters is a set comprising user information. Such information may include anthropometric data, identification data, etc. Preferably, information included in the “info” set is randomly selected. More preferably, the size and index numbers of each data element of the “info” set are randomly defined.

In an embodiment, the machine learning model is a convolutional neural network, CNN, which CNN takes an ECG segment as input in order to identify a user. By preference, the frequency of at which said ECG segment is sampled is between 40 Hz and 300 Hz, more preferably between 60 Hz and 250 Hz, 70 Hz and 200 Hz, 75 Hz and 180 Hz, 80 Hz and 150 Hz, 85 Hz and 130 Hz, 90 Hz and 120 Hz, most preferably the sampling frequency of the ECG is 100 Hz. By preference, two or more ECG segments are used as input in order to identify the user.

A second aspect of the invention relates to a system for cryptographic key pair generation from ECG signals and user authentication based on said ECG signals, the system comprising:
a first server having a Convolutional Neural Network, CNN, model for identifying a user based on ECG data, and an Elliptic Curve Digital Signature Algorithm, ECDSA (or other pluggable signature algorithm);
a second server containing ECG data collected from at least two users, and user account information, the second server being capable of two-way communication with the first server;
at least one wearable or similar device equipped with at least one sensor for capturing ECG signals of a user, communication means and a memory;

The memory of the wearable or similar device is only accessible after the user is authenticated using the CNN model stored on the server, said CNN being trained with the stored user ECG data.

In an embodiment, an HKDF with which a key seed is produced is stored on the server. The key seed is a private key created using the parameters of the CNN model. More preferably, the private key is created based on the entropy of the CNN model, said private key being created using an HKDF. By preference, at least a private key, salt and expand randomness used by the HKDF are stored encrypted on the memory of the wearable device. A key pair comprising the private key, as well as a public key, is produced by means of the HKDF/ECDSA (or other signing algorithm) stored in the server, the recreation of the private key is made impossible without getting access to the salt and info random values stored in the user's wearable device.

In an embodiment, a user network identifier is stored in at the second server and includes a unique identification code of the wearable or similar device assigned to the user. By preference, the user can only be authenticated if the unique identification code of the wearable device matches the identity of the user to whom the device is assigned. In this way, it is possible to increase the security of the system as well as the security of the user since a failure to match the user to the device upon an authentication attempt can be used to trigger an alert that an unauthorized user has gained possession of the device. If even higher security is necessary, a predetermined number of individuals, including the user, must first be authenticated before the keys of the user can be recreated/recompiled. This number of individuals which must be authenticated before recreation/recompilation of the keys is allowed can be raised, according to the desired level of security. By preference all of the predetermined individuals must be authenticated before recreation/recompilation of the keys is allowed.

In an embodiment, the user identifier (Network Identifier) stored in the second server includes a one mnemonic for restoring user access. In this way, the wearable or similar device is reported to be lost, the user can restore access in another device, by preference, by having a new private key created based on the parameters of machine learning model stored in the server. More preferably, a new machine learning model is created as well as new salt with which a private key and a public key can be created. The information may be stored in a cloud storage service, preferably as one or more files with limited transmission capabilities.

In an embodiment, the HKDF is stored in a first server and the user information stored in at least a second server, said information being stored encrypted. In this way the first server is may be used only as a data processor, while the at least second server can be assigned to a data controller (i.e. tech partner, government, etc). This enables the data controller to choose how and where they are going to store the three main key outcomes which are the weight file, info and salt values.

However, it is obvious that the invention is not limited to this application. The method according to the invention can be applied using all sorts of electrophysiological signals, e.g. Electrocardiogramyography, Electroencephalography, Electrocorticography, Electrooculography, Electroolfactography, Electroretinography, Electronystagmography, Electrocochleography, Electroantennography, Electrogastrography, Electrogastroenterogram, Electroglottography, Electropalatography, etc.

The invention is further described by the following non-limiting examples which further illustrate the invention, and are not intended to, nor should they be interpreted to, limit the scope of the invention.

### DESCRIPTION OF FIGURES

With as a goal illustrating better the properties of the invention the following presents, as an example and limiting in no way other potential applications, a description of a number of preferred applications of the method for creating a cryptographic key pair generation from ECG signals based on the invention, wherein:

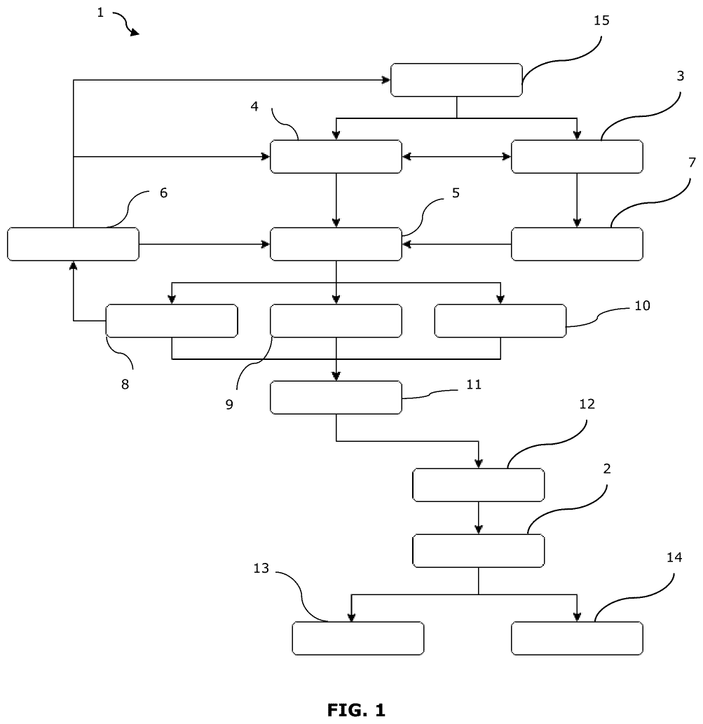

FIG. 1 shows a schematic representation of the system 1 for user registration and authentication. The system 1 is shown including an ECG AI server 2 in connection with an input device 3. Said input device 3 being in this case a wearable device capable of collecting ECG signals. The user 15 interacts with the system 1 via an Input device application 4. The system creates a key pair 6 for the user 15 to serve as an account representation on the system 1 and to train a machine learning model in the ECG AI server 2 for user recognition. A weights calculation model 13 in the server 2 trains the machine learning model assigned to a user 15. As soon as the ECG collection 7 is done and the system 1 has concluded with success the init phase (ceremonial act) 8, the created key pair and weight file are transmitted to the user 16 for backup and to the application 4 where they are stored encrypted. The ECG signals and unique device identifiers such as serial number of the device are collected 7 in order to allow the validation 12 on the server 2 and confirm that the request originates from the same wearable input device 3 that the ceremonial act 8 has occurred. The system 1 creates an encrypted/secure request 5 with the collected ECG data and system info 7 from, for example, an iWatch and iOS App along with the users public address from the user's created key pair 6 to serve as entity identifier in the data set that is stored in the ECG AI server encrypted database 14. The ECG AI server 2 provides three API endpoints 8-10, which endpoints are in contact with the server 2 via the ECG API 11. The Init ceremonial act endpoint 8 can take 20 seconds or more of ECG data along with the rest of the provided information in the request to init the model in the server 2. The Validation endpoint 9 will take at least a single ECG signal along with the rest of the provided information in during a request to validate a user 15. The Reinit 10 endpoint is a privileged endpoint that can be accessed on demand by the user 15 with the permission of the system administrator and will serve as a re-training of the system 10 endpoint in case the model cannot identify the user 15. The ECG AI server validation module 12 makes sure that the incoming request is properly formed and contains all the necessary information for the user 15 while additionally performing checks on the incoming request values to ensure that no invalid requests are performed.

The present invention is in no way limited to the embodiments shown in the FIGURES. On the contrary, methods according to the present invention may be realized in many different ways without departing from the scope of the invention.

### LIST OF NUMBERED ITEMS

1 System
2 ECG AI server
3 Input device
4 Input device application
5 Create Secure Request
6 Keypair Creation
7 ECG Collection/Sys Info Collection
8 Ceremonial Act/Init
9 Validation
10 Retraining/Reinit
11 ECG API
12 Data Validation
13 Weights Calculations
14 Database
15 User

1. An electrocardiogram based two-factor authentication method comprising:
collecting electrocardiogram (ECG) data from a user;
training a machine learning model based on the ECG data; and
generating a private user key and a public user key;
characterized in that, in the generating, the private user key and the public user key are generated by a hash-based function taking a vector containing weight parameters of the machine learning model as input, recreation and/or recompilation of the private key requiring electrocardiogram based user identification by the machine learning model.

2. The method according to claim 1, characterized in that, training the machine learning model includes:
sampling a waveform of the ECG data;
characterized in that, the machine learning model is trained on a mixture of heartbeat data collected from the user as well as data collected from other users.

3. The method according to claim 1, characterized in that, the hash-based function is a key derivation function based on a hash-based message authentication code, HKDF.

4. The method according to claim 3, characterized in that, the generating a private and a public key includes:
extracting the vector containing parameters of the machine learning model;
passing said vector to the HKDF to create a pseudo-random private key;
characterized in that, the pseudo-random private key is passed onto an asymmetric key generation algorithm in order to generate said public key.

5. The method according to claim 4, characterized in that, the asymmetric key generation algorithm is an elliptic curve digital signature algorithm, ECDSA.

6. The method according to claim 4, characterized in that, the extracted vector containing parameters of the machine learning model is encoded in base 64 before being passed onto the HKDF.

7. The method according to claim 6, characterized in that, the method further comprises creating a reduced vector containing only values corresponding to positions of an output vector of encoding the machine learning model in base 64 which positions have a prime index number, said reduced vector being passed onto the HKDF.

8. The method according to claim 3, characterized in that, an info vector and a salt vector are used as initialization vectors of the HKDF.

9. The method according to claim 1, characterized in that, the machine learning model is a convolutional neural network, CNN, which CNN takes an ECG segment as an input in order to identify a user.

10. A system for cryptographic key pair generation from ECG signals and user authentication based on said ECG signals, the system comprising:
a first server having a Convolutional Neural Network, CNN, model for identifying a user based on ECG data, an Elliptic Curve Digital Signature Algorithm ECDSA;
a second server containing ECG data collected from at least two users, and user account information, the second server being capable of two way communication with the first server;
at least one wearable device equipped with at least one sensor for capturing ECG signals of a user, communication means and a memory;
characterized in that, the memory of the at least one wearable device is only accessible after at least the user is authenticated using the CNN model stored on the server, said CNN being trained with the stored user ECG data.

11. The system according to claim 10, characterized in that, an HKDF with which a key seed is produced is stored on the memory of the at least one wearable device.

12. The system according to claim 11, characterized in that, at least a CNN model weights, salt and expand randomness info are used by the HKDF are stored encrypted on the memory of the at least one wearable device.

13. The system according to claim 10, characterized in that, a user network identifier is stored in one of the servers, said identifier includes a unique identification code of the at least one wearable device assigned to the user.

14. The system according to claim 13, characterized in that, the user network identifier stored in the server includes a one mnemonic for restoring user access.

15. The system according to claim 11, characterized in that, the HKDF is stored in the first server and the user information and the ECG data is stored in at least the second server, said information and data being stored encrypted.
